(19) United States
(12) Patent Application Publication
(10) Pub. No.: US 2009/0073098 A1
(43) Pub. Date: Mar. 19, 2009

(54) Display module with identification circuit on panel

(75) Inventor: Zi-Sheng Li, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/283,856

(22) Filed: Sep. 15, 2008

(30) Foreign Application Priority Data
Sep. 14, 2007 (TW) 096134494

(51) Int. Cl. G09G 3/36

(52) U.S. Cl. 345/87

(57) ABSTRACT

An exemplary display module includes a panel and an identification circuit including at least two resistors. The identification circuit is disposed on the panel.

### FIELD OF THE INVENTION

The present invention relates to display modules, and especially relates to a display module with an identification circuit on its panel.

### GENERAL BACKGROUND

FIG. 8 is a schematic view of a conventional display module. The display module 10 includes a liquid crystal display (LCD) panel 11, a flexible printed circuit (FPC) 13, a chip 15, and an identification circuit 17. The FPC 13 is welded on the LCD panel 11. The chip 15 and the identification circuit 17 are disposed on the FPC 13. The identification circuit 17 includes a first resistor 171, a second resistor 172, and an output terminal 173. The first resistor 171 is connected between the output terminal 173 and ground, and the second resistor 172 is connected between the output terminal 173 and a wire (not labeled) of the FPC 13. That is, the first resistor 171 and the second resistor 172 form a voltage dividing circuit.

When detecting the identification circuit 17, a detecting terminal of a detecting device is put into contact with the output terminal 173 of the identification circuit 17. However, because the FPC 13 is flexible, it is difficult for an operator to connect the detecting terminal of the detecting device with the output terminal 173 of the identification circuit 17.

Furthermore, the FPC 13 is accommodated in a frame (not shown) once the display module 10 is finally assembled. The FPC 13 takes up more space when the identification circuit 17 is disposed thereon. This is liable to increase a thickness of the whole display module 10.

What is needed, therefore, is a display module that can overcome the above-described deficiencies.

### SUMMARY

A display module includes a panel and an identification circuit including at least two resistors. The identification circuit is disposed on the panel.

Other novel features and advantages will become more apparent from the following detailed description when taken in conjunction with the accompanying drawings.

### BRIEF DESCRIPTION OF THE DRAWINGS

FIG. 1 is a schematic view of a display module according to a first embodiment of the present invention, the display module including a panel and an identification circuit.

FIG. 2 is a more detailed schematic view of the panel of FIG. 1.

FIG. 3 is an equivalent circuit diagram of the identification circuit of FIG. 1.

FIG. 4 is a schematic view of a display module according to a second embodiment of the present invention, the display module including a panel and an identification circuit.

FIG. 5 is an equivalent circuit diagram of the identification circuit of FIG. 4.

FIG. 6 is a schematic view of a display module 80 according to a third embodiment of the present invention, the display module including a panel and an identification circuit.

FIG. 7 is an equivalent circuit diagram of the identification circuit of FIG. 6.

FIG. 8 is a schematic view of a conventional display module.

### DETAILED DESCRIPTION OF EMBODIMENTS

Reference will now be made to the drawings to describe preferred and exemplary embodiments in detail.

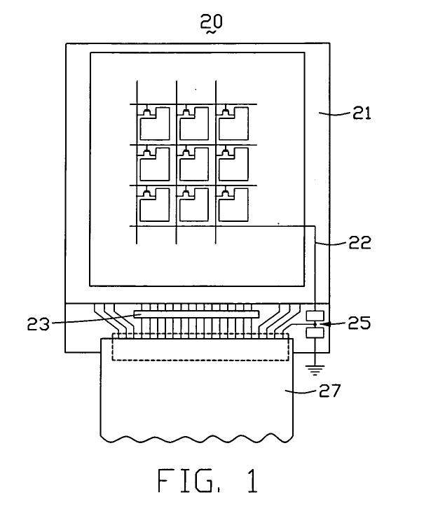

FIG. 1 is a schematic view of a display module 20 according to a first embodiment of the present invention. The display module 20 includes a panel 21, a chip 23, an identification circuit 25, and an FPC 27. The chip 23 and the identification circuit 25 are disposed on the panel 21. The FPC 27 is welded on the panel 21.

FIG. 2 is a more detailed schematic view of the panel 21. The panel 21 can be an LCD panel, and includes a thin film transistor substrate (not shown), a color filter substrate (not shown), and a liquid crystal layer (not shown) interposed therebetween. The panel 21 includes a plurality of electrodes 22. Each of the electrodes 22 is connected to a solder joint 221. The plurality of solder joints 221 is disposed on a solder area 210 of an edge of the thin film transistor substrate. The plurality of solder joints 221 are rectangular and parallel to each other.

The plurality of electrodes 22 and the plurality of solder joints 221 are typically formed by a dry etching method. The electrodes 22 can be gate electrode wires of the thin film transistor substrate or source electrode wires of the thin film transistor substrate. The electrodes 22 can be made of conductive material, such as indium tin oxide (ITO), silver (Ag), silver oxide (Ag₂O), platinum (Pt), or any suitable combination thereof.

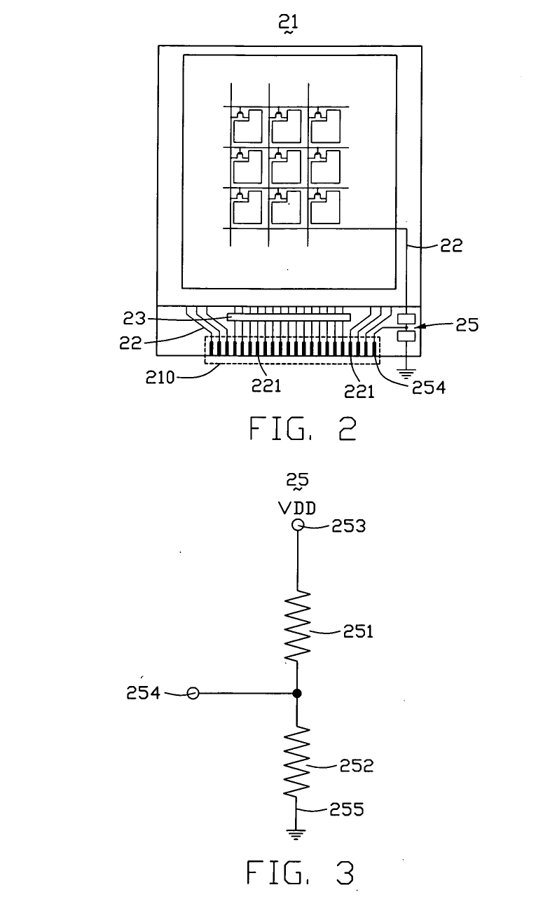

FIG. 3 is an equivalent circuit diagram of the identification circuit 25 of FIG. 1. The identification circuit 25 includes a first resistor 251, a second resistor 252, a first input terminal 253, a second input terminal 255, and an output terminal 254. The first resistor 251 is connected between the first input terminal 253 and the output terminal 254, and the second resistor 252 is connected between the output terminal 254 and the second input terminal 255. That is, the first resistor 251 and the second resistor 252 form a voltage dividing circuit. The first input terminal 253 is connected to one of the electrodes 22. The second input terminal 255 is connected to ground. The output terminal 254 is disposed on the solder area 210 and has the same shape as the solder joints 221. The output terminal 254 is physically parallel to the solder joints 221. A direct current voltage VDD is provided to the identification circuit 25 via the first input terminal 253.

The first resistor 251 and the second resistor 252 are typically formed by a dry etching method, and can be made of conductive material, such as indium tin oxide, silver, silver oxide, platinum, or any suitable combination thereof.

When detecting the identification circuit 25, it is only necessary for a detecting terminal of a detecting device to contact the output terminal 254. Because the thin film transistor substrate is rigid, it is relatively easy for an operator to connect the detecting terminal of the detecting device with the output terminal 254.

Furthermore, because the identification circuit 25 is disposed on the panel 21, the amount of electronic components disposed on the FPC 27 is correspondingly reduced. The FPC 27 can be more easily accommodated in a frame (not shown) of the display module 20, and/or a size of the frame can be reduced. In the latter case, a thickness of the whole display module 20 can be correspondingly reduced.

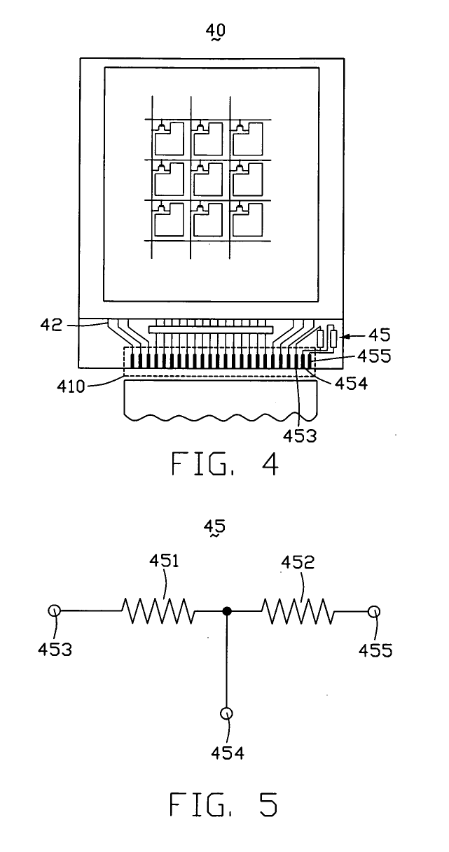

FIG. 4 is a schematic view of a display module 40 according to a second embodiment of the present invention. The display module 40 includes a plurality of electrodes 42 connected to a plurality of solder joints 421, an identification circuit 45, and an FPC 47. FIG. 5 is an equivalent circuit diagram of the identification circuit 45. The identification circuit 25 includes a first resistor 451, a second resistor 452, a first input terminal 453, a second input terminal 455, and an output terminal 454. The display module 40 is similar to the display module 20. However, the first input terminal 453 and the second input terminal 455 are disposed on a solder area 410 and have the same shape as the output terminal 454. The first input terminal 453 and the second input terminal 455 are physically parallel to the output terminal 454.

When detecting the identification circuit 45, firstly, a high level voltage is provided to the first input terminal 453 and a low level voltage is provided to the second input terminal 455. Then the detecting terminal of the detecting device is put into contact with the output terminal 454.

Because the first input terminal 453 and the second input terminal 455 are not connected to any of the electrodes 42, the identification circuit 45 has no influence on inner circuits of the display module 40.

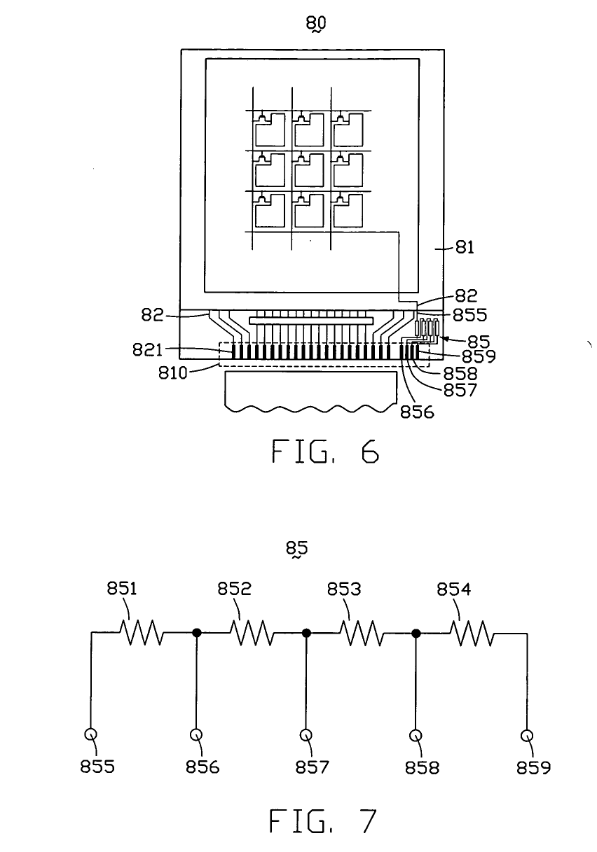

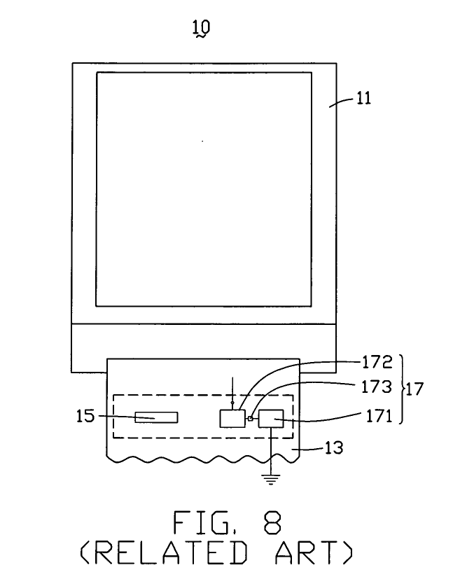

FIG. 6 is a schematic view of a display module 80 according to a third embodiment of the present invention. The display module 80 includes a panel 81, a plurality of electrodes 82 connected to a plurality of solder joints 821, an identification circuit 85, and an FPC 87. FIG. 7 is an equivalent circuit diagram of the identification circuit 85. The display module 80 is similar to the display module 20. However, the identification circuit 85 includes a first resistor 851, a second resistor 852, a third resistor 853, a fourth resistor 854, a first input terminal 855, a second input terminal 859, a first output terminal 856, a second output terminal 857, and a third output terminal 858. The first resistor 851 is connected between the first input terminal 855 and the first output terminal 856. The second resistor 852 is connected between the first output terminal 856 and the second output terminal 857. The third resistor 853 is connected between the second output terminal 857 and the third output terminal 858. The fourth resistor 854 is connected between the third output terminal 858 and the second input terminal 859. The first input terminal 855 is connected to one of the electrodes 82. The second input terminal 859, the first output terminal 856, the second output terminal 857, and the third output terminal 858 are disposed on a solder area 810 and have the same shape as the solder joints 821. The second input terminal 859, the first output terminal 856, the second output terminal 857, and the third output terminal 858 are physically parallel to the solder joints 821.

In alternative embodiments, for example, the first input terminal 855 can be disposed on the solder area 810 and not be connected to any electrode 82. In such case, the first input terminal 855 can have the same shape as the solder joints 821, and can be physically parallel to the solder joints 821.

Furthermore, the identification circuit 85 may have fewer than four resistors, or may have more than four resistors.

It is to be further understood that even though numerous characteristics and advantages of the present embodiments have been set out in the foregoing description, together with details of the structures and functions of the embodiments, the disclosure is illustrative only; and that changes may be made in detail, especially in matters of shape, size, and arrangement of parts within the principles of the invention to the full extent indicated by the broad general meaning of the terms in which the appended claims are expressed.

What is claimed is:

1. A display module, comprising:
a panel; and
an identification circuit disposed on the panel, the identification circuit comprising at least two resistors.

2. The display module of claim 1, wherein the at least two resistors comprise a first resistor and a second resistor, the identification circuit further comprises a first input terminal, a second input terminal, and an output terminal, the first resistor is connected between the first input terminal and the output terminal, and the second resistor is connected between the output terminal and the second input terminal.

3. The display module of claim 2, wherein the panel includes a substrate, a plurality of electrodes disposed on the substrate, and a plurality of solder joints disposed on the substrate, and each of the electrodes is connected to a respective one of the solder joints.

4. The display module of claim 3, wherein the first input terminal is connected to one of the electrodes, the second input terminal is connected to ground, and the output terminal is disposed on the substrate.

5. The display module of claim 4, wherein the output terminal is near the solder joints, has the same shape as each of the solder joints, and is physically parallel to the solder joints.

6. The display module of claim 3, wherein the first input terminal, the second input terminal, and the output terminal are disposed on the substrate.

7. The display module of claim 6, wherein the first input terminal, the second input terminal, and the output terminal are near the solder joints, each of the first input terminal, the second input terminal, and the output terminal has the same shape as each of the solder joints, and the first input terminal, the second input terminal, and the output terminal are physically parallel to the solder joints.

8. The display module of claim 1, wherein the resistors are dry etched resistors.

9. The display module of claim 8, wherein the resistors are made of conductive material.

10. The display module of claim 9, wherein the conductive material is selected from the group consisting of indium tin oxide, silver, silver oxide, and platinum.

11. The display module of claim 1, wherein the at least two resistors comprise a first resistor, a second resistor, a third resistor, and a fourth resistor, the identification circuit further comprises a first input terminal, a second input terminal, a first output terminal, a second output terminal, and a third output terminal, the first resistor is connected between the first input terminal and the first output terminal; the second resistor is connected between the first output terminal and the second output terminal, the third resistor is connected between the second output terminal and the third output terminal, and the fourth resistor is connected between the third output terminal and the second input terminal.

12. The display module of claim 11, wherein the panel includes a substrate, a plurality of electrodes disposed on the substrate, and a plurality of solder joints disposed on the substrate, and each of the electrodes is connected to a respective one of the solder joints.

13. The display module of claim 12, wherein the first input terminal is connected to one of the electrodes, and the second input terminal, the first output terminal, the second output terminal, and the third output terminal are disposed on the substrate.

14. The display module of claim 13, wherein the second input terminal, the first output terminal, the second output terminal, and the third output terminal are near the solder joints, each of the second input terminal, the first output terminal, the second output terminal, and the third output terminal has the same shape as each of the solder joints, and the second input terminal, the first output terminal, the second output terminal, and the third output terminal are physically parallel to the solder joints.

15. The display module of claim 13, wherein the first input terminal, the second input terminal, the first output terminal, the second output terminal, and the third output terminal are disposed on the substrate.

16. The display module of claim 15, wherein the first input terminal, the second input terminal, the first output terminal, the second output terminal, and the third output terminal are near the solder joints, each of the first input terminal, the second input terminal, the first output terminal, the second output terminal, and the third output terminal has the same shape as each of the solder joints, and the first input terminal, the second input terminal, the first output terminal, the second output terminal, and the third output terminal are parallel to the solder joints.

17. The display module of claim 3, wherein the panel is a liquid crystal display panel, and the substrate is a thin film transistor substrate.
